(19) United States
(12) Patent Application Publication
(10) Pub. No.: US 2004/0153277 A1
(43) Pub. Date: Aug. 5, 2004

(54) Analytical parasitic constraints generation technique

(76) Inventors: Pengfei Zhang, Fremont, CA (US); Xisheng Zhang, Sunnyvale, CA (US); Yuping Wu, Beijing (CN)

Correspondence Address: Xisheng Zhang, 1336 Flicker Way, Sunnyvale, CA, 94087, US

(21) Appl. No.: 10/762,781

(22) Filed: Jan. 23, 2004

Related U.S. Application Data
(60) Provisional application No. 60/442,308, filed on Jan. 27, 2003.

(51) Int. Cl. G06F 19/00

(52) U.S. Cl. 702/117

(57) ABSTRACT

An analytical parasitic constraint generation technique for parasitic loading constraints generation based on analytical assessment of circuit nodes time constants. The inventive device includes DC operating point simulation, open circuit time constant calculator, circuit bandwidth estimation, parasitic loading constraints generator. DC operating point simulation calculates the equivalent resistive impedance at each circuit node. The time constant calculator analytically assesses the time constant related to each circuit node based on open-circuit time constant technique. Circuit bandwidth estimation module estimates the bandwidth of the circuit based on the calculated time constants at each node and then compares with band-with requirement. Parasitic loading constraints generator calculates the tolerable excessive parasitic loading at each circuit node to be used in physical synthesis, or to select optimal circuit topology.

### CROSS-REFERENCE TO RELATED APPLICATIONS

This application claims priority to and the benefit of the filing date of provisional patent application Serial No. 60/442,308 filed Jan. 27, 2003.

### BACKGROUND OF THE INVENTION

1. Field of the Invention

The present invention relates generally to constraints generation and more specifically it relates to an analytical parasitic constraint generation technique for parasitic loading constraints generation based on analytical assessment of circuit nodes time constants.

2. Description of the Related Art

It can be appreciated that constraints generation have been in use for years. Typically, constraints generation are comprised of manual estimation of acceptable amount of parasitic loading at critical nodes based on individual designer's experience and rule of thumb, or constraints generation based on extensive numerical circuit simulation and sensitivity analysis at multiple circuit nodes.

The main problem with conventional constraints generation are manual estimation hinders productivity and error prone. Another problem with conventional constraints generation are numerical analysis is often not feasible due to the size and complexity of the circuit under consideration. Another problem with conventional constraints generation are constraints generated with numerical analysis methodology sometimes are not achievable due to lack of physical meaning in the generation process.

While these devices may be suitable for the particular purpose to which they address, they are not as suitable for parasitic loading constraints generation based on analytical assessment of circuit nodes time constants. The main problem with conventional constraints generation are manual estimation hinders productivity and error prone. Another problem is numerical analysis is often not feasible due to the size and complexity of the circuit under consideration. Also, another problem is constraints generated with numerical analysis methodology sometimes are not achievable due to lack of physical meaning in the generation process.

In these respects, the analytical parasitic constraints generation technique according to the present invention substantially departs from the conventional concepts and designs of the prior art, and in so doing provides an apparatus primarily developed for the purpose of parasitic loading constraints generation based on analytical assessment of circuit nodes time constants.

### SUMMARY OF THE INVENTION

In view of the foregoing disadvantages inherent in the known types of constraint generation now present in the prior art, the present invention provides a new an analytical parasitic constraints generation technique construction wherein the same can be utilized for parasitic loading constraints generation based on analytical assessment of circuit nodes time constants.

The general purpose of the present invention, which will be described subsequently in greater detail, is to provide a new an analytical parasitic constraints generation technique that has many of the advantages of the constraints generation mentioned heretofore and many novel features that result in a new an analytical parasitic constraints generation technique which is not anticipated, rendered obvious, suggested, or even implied by any of the prior art constraints generation, either alone or in any combination thereof.

To attain this, the present invention generally comprises DC operating point simulation, open circuit time constant calculator, circuit bandwidth estimation, parasitic loading constraints generator. DC operating point simulation calculates the equivalent resistive impedance at each circuit node. The time constant calculator analytically assesses the time constant related to each circuit node based on open-circuit time constant technique. Circuit bandwidth estimation module estimates the bandwidth of the circuit based on the calculated time constants at each node and then compares with bandwidth requirement. Parasitic loading constraints generator calculates the tolerable excessive parasitic loading at each circuit node to be used in physical synthesis, or to select optimal circuit topology.

There has thus been outlined, rather broadly, the more important features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide an analytical parasitic constraint generation technique that will overcome the shortcomings of the prior art devices.

An object of the present invention is to provide an analytical parasitic constraint generation technique in layout constrains generation with OCT (open circuit time) constant for critical nodes.

An object of the present invention is to provide an analytical parasitic constraint generation technique for parasitic loading constraints generation based on analytical assessment of circuit nodes time constants.

Another object is to provide an analytical parasitic constraint generation technique that explores quickly and analytically the candidate circuit topology for a matrix of performance specification, especially circuit bandwidth.

Another object is to provide an analytical parasitic constraint generation technique that generates parasitic loading constraints that can be used in physical synthesis.

Another object is to provide an analytical parasitic constraint generation technique that optimizes circuit performance quickly and analytically by running through what-if scenarios of placement options.

Another object is to provide an analytical parasitic constraint generation technique that selects the optimal routing solution by running through what-if scenarios quickly and analytically.

Another object is to provide an analytical parasitic constraint generation technique that selects optimal parasitic elements for optimizing tuning frequency response of a RF circuit.

Another object is to provide an analytical parasitic constraint generation technique that quickly analyzes circuit to identify the dominant pole(s) to assess the speed of an unknown circuit.

Other objects and advantages of the present invention will become obvious to the reader and it is intended that these objects and advantages be within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1—Concept of Open Circuit Time Constant.

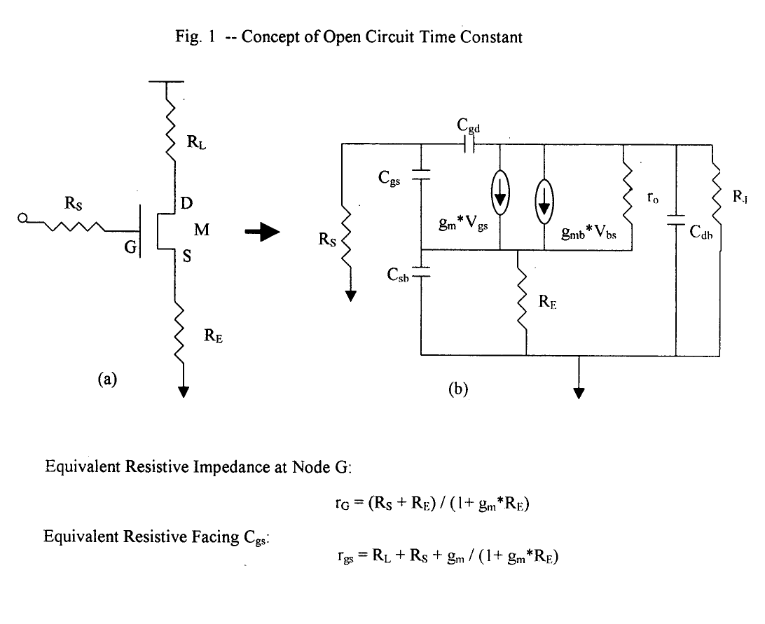

FIG. 2—Parasitic Loading Constraints Generation Flow Chart.

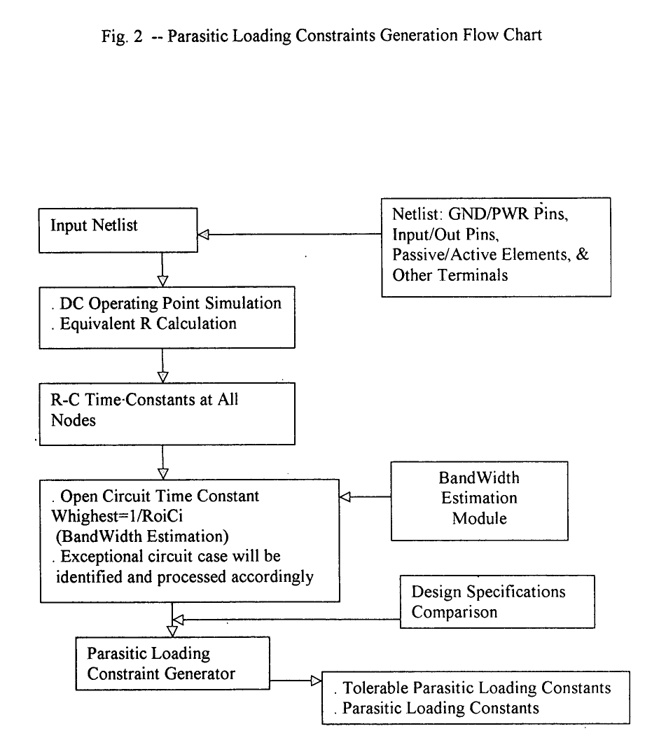

FIG. 3—Means of Circuit Physical Synthesis, Selecting Optimal Circuit Topology Parasitic Capacitance, Parasistic Inductance, and Routing Solution, and Means of Stability Analysis and Optimizing Circuit Performance Flow Chart

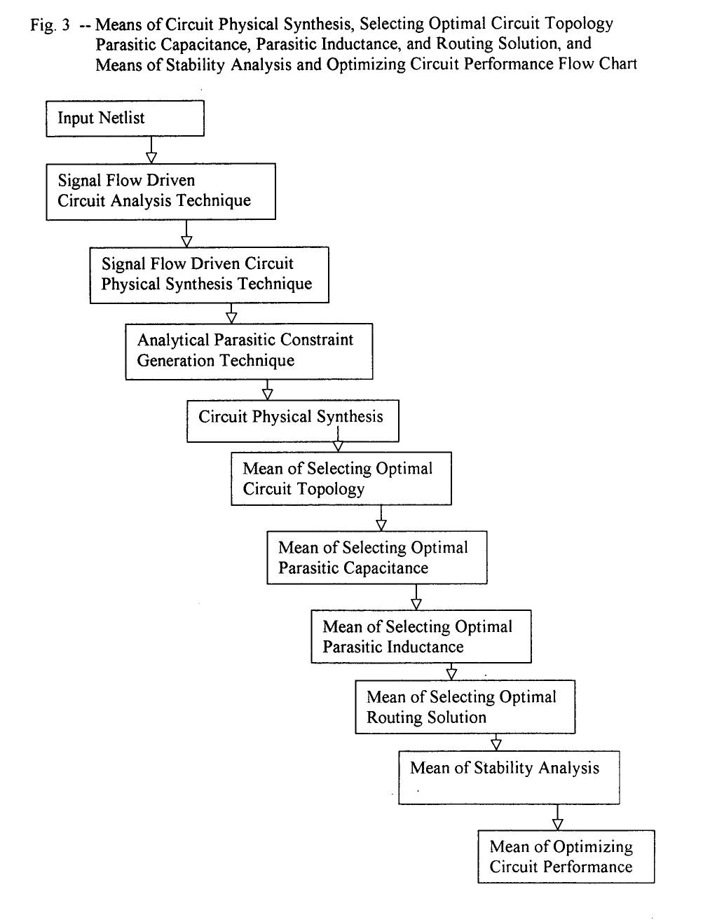

### DETAILED DESCRIPTION OF THE INVENTION

Turning now descriptively to the drawings, in which similar reference characters denote similar elements throughout the several views, the attached figures illustrate an analytical parasitic constraint generation technique, which comprises DC operating point simulation, open circuit time constant calculator, circuit bandwidth estimation, parasitic loading constraints generator. DC operating point simulation calculates the equivalent resistive impedance at each circuit node. The time constant calculator analytically assesses the time constant related to each circuit node based on open-circuit time constant technique. Circuit bandwidth estimation module estimates the bandwidth of the circuit based on the calculated time constants at each node and then compares with bandwith requirement. Parasitic loading constraints generator calculates the tolerable excessive parasitic loading at each circuit node to be used in physical synthesis, or to select optimal circuit topology.

DC operating point simulation calculates the equivalent resistive impedance at each circuit node. Numerical simulator is called in to calculate DC operating point and thus the equivalent resistive impedance at each node. Numerical simulators can be one of the commercially available tools such as SPICE or Spectre. Built-in simulator is another alternative to calling external simulators, as DC operating point simulation is simple and fast.

The time constant calculator analytically assesses the time constant related to each circuit node based on open-circuit time constant technique. Open circuit time constant of each node in the circuit is calculated by multiply the equivalent resistive impedance at this circuit node with the total capacitance at the same node. An alternative is to perform a transient simulation with numerical simulator at each stage of the circuit and then calculate the time constant at each node.

Circuit bandwidth estimation module estimates the bandwidth of the circuit based on the calculated time constants at each node and then compares with bandwith requirement. As most circuits have a dominant pole, the bandwidth of the complete circuit can be approximated with the summation of the reciprocals of each time constant at each circuit node. Some exceptional circuit where open circuit time constant approach does not apply shall be identified and processed accordingly. Capacitive loading at various nodes can be user input information or automatic extracted values.

Parasitic loading constraints generator calculates the tolerable excessive parasitic loading at each circuit node to be used in physical synthesis, or to select optimal circuit topology. Comparing the bandwidth estimated with the circuit design specification, the maximum tolerable parasitic loading at each circuit node can be calculated, which can be used for circuit physical synthesis and/or circuit topology selection. In RF circuits, if inductive tuning load is used, the optimal parasitic capacitance can also be generated to achieve optimized tuning frequency response. However, if capacitive tuning load is used, the optimal parasitic inductance can also be generated to achieve optimized tuning frequency response. The same methodology can be expanded to stability analysis to generate an optimal range of the parasitic loading values.

Components in this invention are suggested being used in series, i.e. to perform DC OP simulation and then to calculate time constant at each circuit node. The complete circuit bandwidth is then estimated and finally the parasitic loading constraints can be generated against a design specification. However, each component can be used separately in other context. Invention can be used to generate physical synthesis constraints. Invention can also be used in circuit optimization. Invention can be used in automatic circuit synthesis at initial topology exploration stage.

The required value of bandwidth is specified by the designer. a. The operating-points catcher runs spice OP analysis to get the circuit operating points. b. The open-circuit time constant calculator calculates the open circuit time constant (OCtime) according to the DC OP for each circuit stage. c. The overall circuit bandwidth calculator calculates the bandwidth, BWcalc without parasitics considered. d. The allowed maximum open circuit time constant calculator calculates the allowed maximum open-circuit time constant based on the formula for each stage. OCtime_new=OCtime*BWcalc/Bwspec where OCtime is open-circuit time constant without net-related parasitics considered, BWcalc is the bandwidth calculated without net-related parasitics, and BWspec is the required bandwidth. e. The parasitic RCL calculator calculates the net-related parasitic resistance, capacitance, and inductance for each net based on the OCtime_new, which is the reverse procedure to calculate the open-circuit time constant. f. The parasitic constraints on non-critical signal path also can be calculated by scaling the original OC time with BWcalc/BWspec. The parasitic constraints will be shown as the net parasitic resistance, capacitance, and inductance. And only when BWcalc is greater than BWspec, this automatic parasitic constraints generation method can be valid.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A signal flow driven circuit analysis technique by tracing circuit signal flow so that, analyzing a circuit, and partitioning a circuit based on functionality and criticality, and generating multitude circuit layout constraints are done by software program automatically.

2. A signal flow driven circuit physical synthesis technique by tracing circuit signal flow so that, placing and routing circuit cell physical layout based on giving critical signal path with high priority are done by software program automatically.

3. An analytical parasitic constraint generation technique for layout constraint generation using open circuit time constant technique on multitude critical nodes.

4. A analytical parasitic constraint generation technique of claim 3 comprising:
(a) Providing a memory that is able to store a circuit netlist employing input and output pins, any other terminal pins, power and ground terminals, active device elements, and passive device elements; and
(b) Storing said circuit netlist in said memories; and
(c) Providing a memory that is able to store a series of design specifications in said memory; and
(d) Storing said series of design specifications in said memory; and
(e) Calculating equivalent resistive impedance at each circuit node of said circuit netlist by performing DC operating point simulation using a numerical simulator such as SPICE; and
(f) Calculating equivalent resistive impedance at each circuit node of said circuit netlist by performing transient simulation using a numerical simulator such as SPICE; and
(g) Utilizing the analytical parasitic constraint generation technique of claim 3 wherein said the open circuit time constant technique to assessing a time constant of each circuit node; and
(h) Providing a memory that is able to store a bandwidth estimation module in said memory; and
(i) Storing said bandwidth estimation module in said memory; and
(j) Utilizing said bandwidth estimation module to estimates a circuit bandwidth based on said time constant at each circuit node and said circuit bandwidth will be compared with said series of design specification; and
(k) Providing a memory that is able to store a parasitic loading constraints generator in said memory; and
(l) Storing said parasitic loading constraints generator in said memory; and
(m) Utilizing said parasitic loading constraints generator to calculates a tolerable excessive parasitic loading at each circuit node for circuit physical synthesis at initial topology exploration stage.

5. A mean of circuit physical synthesis utilizing:
(a) The analytical parasitic constraint generation technique of claim 3; and
(b) The signal flow driven circuit physical synthesis technique of claim 2; and
(c) The signal flow driven circuit analysis technique of claim 1.

6. A mean of selecting optimal circuit topology utilizing the analytical parasitic constraint generation technique of claim 3 wherein said parasitic loading constraints.

7. A mean of selecting optimal parasitic capacitance utilizing the analytical parasitic constraint generation technique of claim 3 wherein said parasitic loading constraints for optimized tuning frequency response of a RF circuit.

8. A mean of selecting optimal parasitic inductance utilizing the analytical parasitic constraint generation technique of claim 3 wherein said parasitic loading constraints for optimized tuning frequency response of a RF circuit.

9. A mean of stability analysis utilizing the analytical parasitic constraint generation technique of claim 3 wherein said parasitic loading constraints to generate an optimal range of the parasitic loading values.

10. A mean of optimizing circuit performance utilizing the analytical parasitic constraint generation technique of claim 3 quickly and analytically by running through what-if scenarios of placement options.

11. A mean of selecting optimal routing solution utilizing the analytical parasitic constraint generation technique of claim 3 quickly and analytically by running through what-if scenarios.

12. A mean of identifying a dominant pole[s] utilizing the analytical parasitic constraint generation technique of claim 3 for assessing the speed of an unknown circuit.
